(19) United States
(12) Patent Application Publication
(10) Pub. No.: US 2015/0324247 A1
(43) Pub. Date: Nov. 12, 2015

(54) FAILURE INFORMATION MANAGEMENT SYSTEM AND FAILURE INFORMATION MANAGEMENT APPARATUS

(71) Applicant: Daiki HOSHI, Tokyo (JP)

(72) Inventor: Daiki HOSHI, Tokyo (JP)

(21) Appl. No.: 14/682,189

(22) Filed: Apr. 9, 2015

(30) Foreign Application Priority Data
May 7, 2014 (JP) 2014-096126

(51) Int. Cl. G06F 11/07

(52) U.S. Cl. CPC G06F 11/0769; G06F 11/0751

(57) ABSTRACT

A failure information management system includes a failure information management apparatus; and a device. The failure information management apparatus includes an accepting unit, a managing unit, a generating unit, and an output unit. The accepting unit accepts an input for generating failure information on a failure that has occurred in the device. The managing unit manages the failure information generated based on the input accepted by the accepting unit. The generating unit generates display information indicating that the failure indicated by the failure information is managed by the failure information management apparatus. The output unit outputs the display information to the device. The device includes a display control unit to causes a display unit to perform display based on the display information.

### CROSS-REFERENCE TO RELATED APPLICATIONS

The present application claims priority to and incorporates by reference the entire contents of Japanese Patent Application No. 2014-096126 filed in Japan on May 7, 2014.

### BACKGROUND OF THE INVENTION

1. Field of the Invention

The present invention relates to a failure information management system and a failure information management apparatus.

2. Description of the Related Art

Conventionally, there is known a failure information management apparatus that manages, as a ticket, failure information on a failure that has occurred in a device (see, for example, Japanese Laid-open Patent Publication No. 2011-100283). For example, the failure information management apparatus as described above accepts an input for generating a ticket for a failure from a contact person at a help desk when the contact person receives a report from a detector who has detected a failure in a device, and then the failure information management apparatus generates and manages the ticket.

However, in the conventional technology as described above, redundant failure information may be generated.

Therefore, there is a need for a failure information management system and a failure information management apparatus that are capable of preventing generation of redundant failure information.

### SUMMARY OF THE INVENTION

It is an object of the present invention to at least partially solve the problems in the conventional technology.

According to an embodiment, a failure information management system includes a failure information management apparatus; and a device. The failure information management apparatus includes an accepting unit, a managing unit, a generating unit, and an output unit. The accepting unit accepts an input for generating failure information on a failure that has occurred in the device. The managing unit manages the failure information generated based on the input accepted by the accepting unit. The generating unit generates display information indicating that the failure indicated by the failure information is managed by the failure information management apparatus. The output unit outputs the display information to the device. The device includes a display control unit to causes a display unit to perform display based on the display information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating an example of a configuration of a failure information management system of a first embodiment;

FIG. 2 is a block diagram illustrating an example of a configuration of a failure information management apparatus of the first embodiment;

FIG. 3 is a diagram illustrating an example of failure information managed by a managing unit of the first embodiment;

FIG. 4 is a block diagram illustrating an example of a configuration of a device of the first embodiment;

FIG. 5 is a diagram illustrating an example of display information of the first embodiment;

FIG. 6 is a sequence diagram illustrating an example of a display process performed by the failure information management system of the first embodiment:

FIG. 7 is a sequence diagram illustrating an example of a display cancellation process performed by the failure information management system of the first embodiment;

FIG. 8 is a block diagram illustrating an example of a configuration of a failure information management system of a second embodiment;

FIG. 9 is a block diagram illustrating an example of a configuration of a failure information management apparatus of the second embodiment;

FIG. 10 is a block diagram illustrating an example of a configuration of a mediation device of the second embodiment;

FIG. 11 is a block diagram illustrating an example of a configuration of a device of the second embodiment;

FIG. 12 is a sequence diagram illustrating an example of a display process performed by the failure information management system of the second embodiment;

FIG. 13 is a sequence diagram illustrating an example of a display cancellation process performed by the failure information management system of the second embodiment; and

FIG. 14 is a diagram illustrating an example of a hardware configuration of each of the device of the embodiments and a modification.

### DETAILED DESCRIPTION OF THE PREFERRED EMBODIMENTS

Exemplary embodiments will be described in detail below with reference to the accompanying drawings.

### First Embodiment

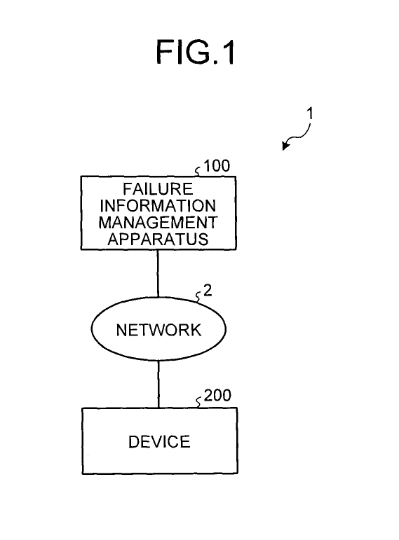

FIG. 1 is a block diagram illustrating an example of a configuration of a failure information management system 1 of a first embodiment. As illustrated in FIG. 1, the failure information management system 1 includes a failure information management apparatus 100 and a device 200. The failure information management apparatus 100 and the device 200 are connected to each other via a network 2. The network 2 is implemented by, for example, a local area network (LAN), a wide area network (WAN), the Internet, or the like.

In the first embodiment, an example is illustrated in which the number of the devices is one; however, the number of the devices is not limited to the example and may be two or more.

The failure information management apparatus 100 accepts an input for generating failure information (a ticket) on a failure that has occurred in the device 200 that is a management target, generates the failure information, and manages the failure information. The failure information management apparatus 100 is implemented by, for example, a computer. In the first embodiment, an example will be described in which the failure information management apparatus 100 is installed at a help desk in a call center or the like; however, the installation location of the failure information management apparatus 100 is not limited to this example.

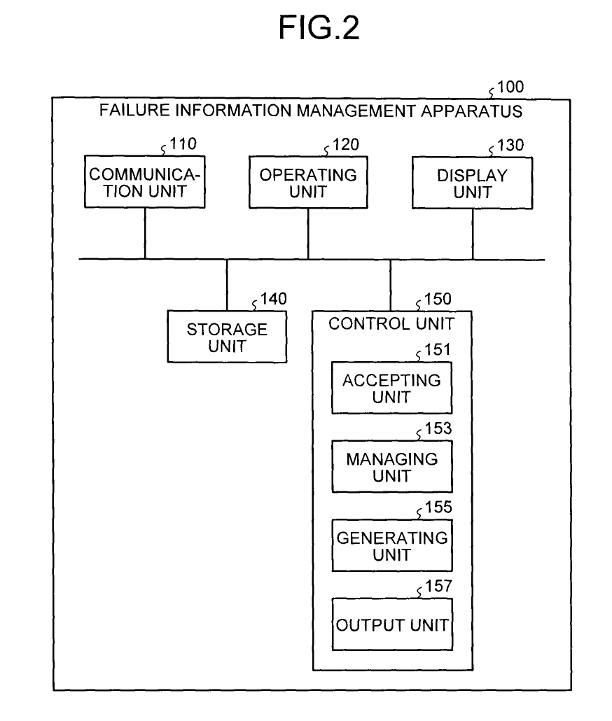

FIG. 2 is a block diagram illustrating an example of a configuration of the failure information management apparatus 100 of the first embodiment. As illustrated in FIG. 2, the failure information management apparatus 100 includes a communication unit 110, an operating unit 120, a display unit 130, a storage unit 140, and a control unit 150.

The communication unit 110 communicates with an external device, such as the device 200, via the network 2, and is implemented by a communication device, such as a network interface card (NIC).

The operating unit 120 is used to input various operations, and is implemented by an input device, such as a keyboard, a mouse, a touch pad, or a touch panel.

The display unit 130 displays various screens, and is implemented by a display device, such as a liquid crystal display or a touch panel display.

The storage unit 140 stores therein various programs executed by the failure information management apparatus 100, data used in various types of processing performed by the failure information management apparatus 100, and the like. The storage unit 140 is implemented by, for example, at least one of a magnetic storage device, an optical storage device, and an electrical storage device, such as a hard disk drive (HDD), a solid state drive (SSD), a memory card, an optical disk, or a random access memory (RAM).

The control unit 150 controls each of the units of the failure information management apparatus 100, and is implemented by a control device, such as a central processing unit (CPU). The control unit 150 includes an accepting unit 151, a managing unit 153, a generating unit 155, and an output unit 157. The control unit 150 activates (executes) the programs stored in the storage unit 140 and implements the accepting unit 151, the managing unit 153, the generating unit 155, and the output unit 157 as software.

The accepting unit 151 accepts an input for generating failure information on a failure that has occurred in the device 200.

In the first embodiment, a contact person at the help desk receives a report from a detector who has detected the failure that has occurred in the device 200, and the contact person performs an operation input for generating failure information on the failure to the failure information management apparatus 100 via the operating unit 120. Accordingly, the accepting unit 151 accepts the operation input.

Meanwhile, it is preferable that a person who performs an input for generating the failure information is a user of the failure information management apparatus 100, but is not limited to the contact person as described above. For example, the detector who has detected the failure in the device 200 may perform an input for generating the failure information to the failure information management apparatus 100 via the network 2 or via the communication unit 110 by using a personal computer (PC) or a smartphone.

The managing unit 153 manages the failure information generated based on the input accepted by the accepting unit 151. Specifically, the managing unit 153 generates the failure information based on the input accepted by the accepting unit 151, and manages the failure information on the storage unit 140. Namely, the managing unit 153 stores and manages the failure information in the storage unit 140.

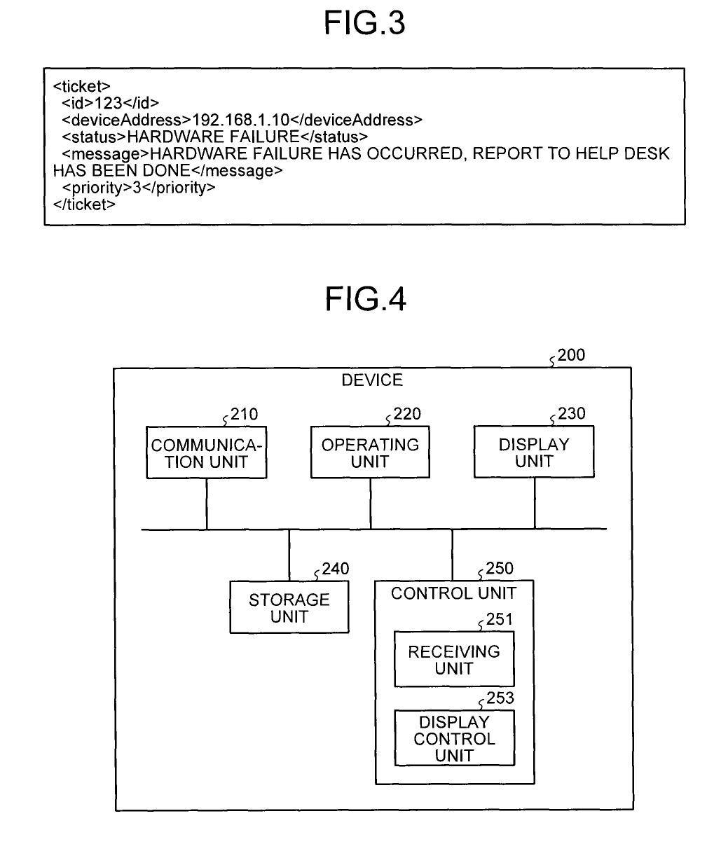

FIG. 3 is a diagram illustrating an example of the failure information managed by the managing unit 153 of the first embodiment. In the example illustrated in FIG. 3, a ticket as the failure information is written in an Extensible Markup Language (XML); however, the format of the failure information is not limited to this example.

Further, in the example illustrated in FIG. 3, the failure information contains an “id”, a “deviceAddress”, a “status”, a “message”, and a “priority”; however, information contained in the failure information is not limited to this example. For example, the failure information may further contain other information, or may not contain the message and the priority.

The “id” is an identifier for identifying the failure information, and is set to “123” in this example. In the first embodiment, when an operation input accepted by the accepting unit 151 is an operation input for generating new failure information, the “id” is not contained in the operation input and the managing unit 153 generates the id. On the other hand, when the operation input accepted by the accepting unit 151 is an operation input for updating already-managed failure information, the “id” is contained in the operation input in order to identify the failure information to be updated; however, it is not limited thereto.

The “deviceAddress” is an example of device address information indicating an address of the device 200, in which the failure has occurred, on the network 2, and is set to “192.168.1.10” in this example. In the first embodiment, it is assumed that the “deviceAddress” is the IP address; however, it is not limited thereto. For example, a host name or the like may be used.

Further, in the first embodiment, the “deviceAddress” is contained in the operation input when the operation input accepted by the accepting unit 151 is an operation input for generating new failure information, or when the operation input accepted by the accepting unit 151 is an operation input for updating the “deviceAddress” in already-managed failure information; however, it is not limited thereto.

The “status” is an example of status information indicating a status of the device 200 in which the failure has occurred, and is set to “hardware failure” in this example. For example, the “status” indicates a type of a failure that has occurred upon occurrence of the failure, and indicates “recovered” or the like upon recovery from the failure.

In the first embodiment, it is assumed that the “status” indicates a type of a failure that has occurred when the operation input accepted by the accepting unit 151 contains the “status” and the operation input is an operation input for generating new failure information, and the “status” indicates recovery from the failure when the operation input is an operation input for updating already-managed failure information; however, it is not limited thereto.

The “message” is an example of display information indicating that the failure that has occurred in the device 200 is managed by the failure information management apparatus 100 (the failure information management system 1), and is set to “hardware failure has occurred, report to help desk is done”.

In the first embodiment, it is assumed that when the operation input accepted by the accepting unit 151 is an operation input for generating new failure information, the generating unit 155 (to be described later) generates the “message” and adds the “message” to the failure information so that the “message” is contained in the failure information managed by the managing unit 153; however, it is not limited thereto. For example, the “message” may not be contained in the failure information managed by the managing unit 153.

The “priority” is an example of priority information indicating priority of the status (status information), and is set to “3” in this example. In the first embodiment, a greater value in the “priority” indicates a higher priority; however, it is not limited thereto.

Further, in the first embodiment, when the operation input accepted by the accepting unit 151 is an operation input for generating new failure information, the “priority” is contained in the operation input; however, it is not limited thereto. The “priority” may not be contained in the operation input, but may be generated by the managing unit 153.

The generating unit 155 generates display information indicating that the failure that has occurred in the device 200 (the failure corresponding to the failure information managed by the managing unit 153) is managed by the failure information management apparatus 100 (the failure information management system 1).

Specifically, the generating unit 155 generates the display information when the status information contained in the failure information indicates occurrence of a failure. In the first embodiment, as described above with reference to FIG. 3, it is assumed that the display information has a content corresponding to the failure that has occurred; however, it is not limited thereto. For example, a content of a standard error message may be used. The generating unit 155 adds the generated display information to the failure information used for generating the display information so that the display information is contained in the failure information managed by the managing unit 153.

Further, when the status information contained in the failure information indicates recovery from the failure, the generating unit 155 generates a display cancellation command to cancel display of the display information.

The output unit 157 outputs the display information generated by the generating unit 155 to the device 200. In the first embodiment, it is assumed that the output unit 157 outputs not only the display information but also the failure information containing the display information to the device 200; however, it is not limited thereto. Consequently, the output unit 157 outputs the priority information or the like together with the display information to the device 200.

Further, the output unit 157 outputs the display cancellation command generated by the generating unit 155 to the device 200. In the first embodiment, it is assumed that, when the generating unit 155 generates the display cancellation command, the output unit 157 outputs the display cancellation command and the failure information used for generating the display cancellation command to the device 200; however, it is not limited thereto.

Incidentally, the output unit 157 performs an output to the device 200 on the basis of the device address information contained in the failure information. The output to the device 200 may be performed by using communication using a dedicated protocol or by using an electronic mail or the like.

The device 200 may be any device connectable to the network 2. For example, the device 200 may be an image forming apparatus, such as a printer, a copier, a multifunction peripheral (MFP), a scanner, or a facsimile machine, may be any of various electronic devices, such as a projector, a camera, an air conditioner, a refrigerator, a fluorescent light, an automatic vending machine, or a handheld terminal, may be a PC, or may be a tablet. The MFP has at least two of a copying function, a printing function, a scanner function, and a facsimile function.

FIG. 4 is a block diagram illustrating an example of a configuration of the device 200 of the first embodiment. As illustrated in FIG. 4, the device 200 includes a communication unit 210, an operating unit 220, a display unit 230, a storage unit 240, and a control unit 250.

The communication unit 210 communicates with an external apparatus, such as the failure information management apparatus 100, via the network 2, and is implemented by a communication device, such as a NIC.

The operating unit 220 inputs various operations, and is implemented by an input device, such as a keyboard, a mouse, a touch pad, or a touch panel.

The display unit 230 displays various screens, and is implemented by a display device, such as a liquid crystal display or a touch panel display.

The storage unit 240 stores therein various programs executed by the device 200, data used in various processes performed by the device 200, and the like. The storage unit 240 is implemented by, for example, at least one of a magnetic storage device, an optical storage device, and an electrical storage device, such as an HDD, an SSD, a memory card, an optical disk, or a RAM.

The control unit 250 controls each of the units of the device 200, and is implemented by a control device, such as a CPU. The control unit 250 includes a receiving unit 251 and a display control unit 253. The control unit 250 activates (executes) the programs stored in the storage unit 240 and implements the receiving unit 251 and the display control unit 253 as software.

The receiving unit 251 receives the display information from the failure information management apparatus 100. In the first embodiment, as described above, the receiving unit 251 receives the failure information containing the display information from the failure information management apparatus 100. Further, the receiving unit 251 receives the display cancellation command from the failure information management apparatus 100. In the first embodiment, as described above, the receiving unit 251 receives the display cancellation command and the failure information used for generating the display cancellation command from the failure information management apparatus 100.

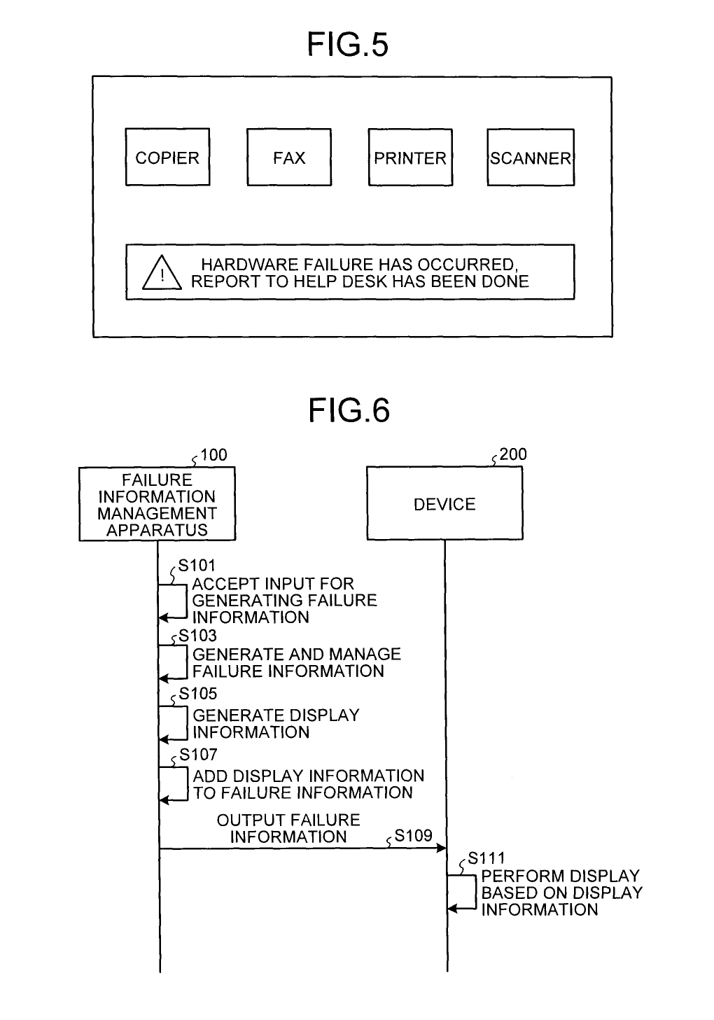

The display control unit 253 causes the display unit 230 to perform display based on the display information received by the receiving unit 251. In the first embodiment, the display control unit 253 causes the display unit 230 to display the content indicated by the display information as illustrated in FIG. 5; however, it is not limited thereto. Incidentally, in the first embodiment, a display format of the display information output by the failure information management apparatus 100 matches a format that is displayable by the individual apparatus 200, and the display control unit 253 displays the display information as it is. However, if the display format of the display information differs from the format that is displayable by the individual apparatus 200, the display information is displayed on the display unit 230 after the display format is converted to the format that is displayable by the individual apparatus 200.

Meanwhile, the display control unit 253 may control, based on the priority information, the display performed based on the display information on the display unit 230. Specifically, when a plurality of combinations of the display information and the priority information are present, that is, when the receiving unit 251 receives a plurality of pieces of the failure information from the failure information management apparatus 100, the display control unit 253 causes the display unit 230 to display the display information paired with the priority information indicating the highest priority (the display information contained in the failure information containing the priority information indicating the highest priority).

For example, it is assumed that the receiving unit 251 receives the failure information with the priority of “1” in addition to the failure information with the priority of “3” as described above from the failure information management apparatus 100. In this case, the display control unit 253 causes the display unit 230 to display “hardware failure has occurred, report to help desk has been done”, which is the message contained in the failure information with the priority of “3” indicating the highest priority.

Further, the display control unit 253 causes the display unit 230 to cancel the display performed based on the display information according to the display cancellation command. Specifically, when the receiving unit 251 receives the display cancellation command and the failure information used for generating the display cancellation command, the display control unit 253 specifies a display to be a target of the display cancellation command from among currently-displayed displays from the message in the failure information, and cancels the display.

FIG. 6 is a sequence diagram illustrating an example of a display process performed by the failure information management system 1 of the first embodiment.

First, the accepting unit 151 of the failure information management apparatus 100 accepts an input for generating failure information on a failure that has occurred in the device 200 (Step S101).

Subsequently, the managing unit 153 of the failure information management apparatus 100 generates the failure information based on the input accepted by the accepting unit 151, and manages the failure information on the storage unit 140 (Step S103).

Then, if status information contained in the failure information indicates occurrence of a failure, the generating unit 155 of the failure information management apparatus 100 generates display information (Step S105), and adds the generated display information to the failure information used for generating the display information so that the display information is contained in the failure information managed by the managing unit 153 (Step S107).

Subsequently, the output unit 157 of the failure information management apparatus 100 outputs the failure information containing the display information generated by the generating unit 155 to the device 200 (Step S109), and the receiving unit 251 of the device 200 receives the failure information.

Then, the display control unit 253 of the device 200 causes the display unit 230 to perform display based on the display information contained in the failure information received by the receiving unit 251 (Step S111).

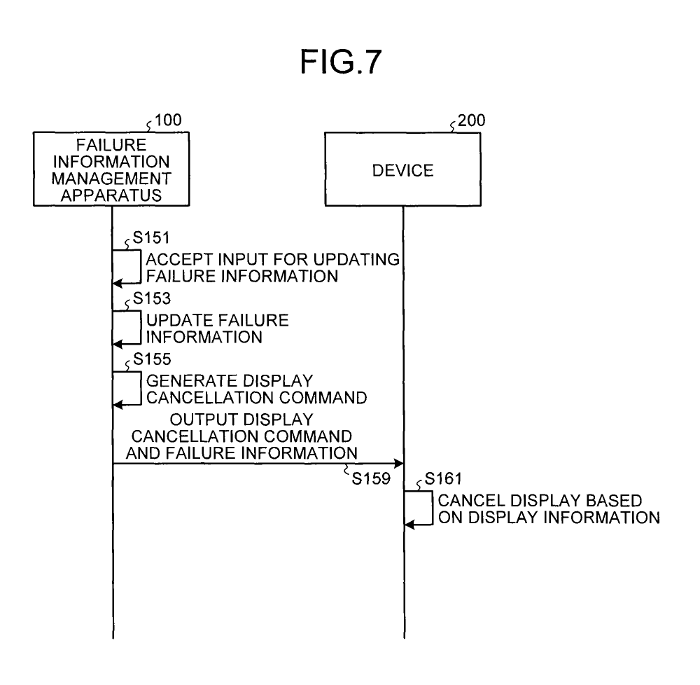

FIG. 7 is a sequence diagram illustrating an example of a display cancellation process performed by the failure information management system 1 of the first embodiment.

First, the accepting unit 151 of the failure information management apparatus 100 accepts an input for updating failure information on a failure that has occurred in the device 200 (Step S151).

Subsequently, the managing unit 153 of the failure information management apparatus 100 updates the failure information based on the input accepted by the accepting unit 151 (Step S153). In this example, the managing unit 153 updates status information (“status”) in the failure information with “recovered”.

Then, because the status information contained in the failure information indicates recovery from the failure, the generating unit 155 of the failure information management apparatus 100 generates a display cancellation command (Step S155).

Subsequently, the output unit 157 of the failure information management apparatus 100 outputs the display cancellation command generated by the generating unit 155 and the failure information used for generating the display cancellation command to the device 200 (Step S159), and the receiving unit 251 of the device 200 receives the display cancellation command and the failure information.

Then, the display control unit 253 of the device 200 causes the display unit 230 to cancel display based on display information contained in the failure information received by the receiving unit 251 (Step S161).

As described above, in the first embodiment, if failure information on a failure indicates occurrence of a failure in the failure information management apparatus 100 that manages the failure that has occurred in the device 200, the device 200 displays a notice indicating that the failure is managed by the failure information management apparatus 100. Therefore, even when a different detector detects occurrence of the failure in the device 200, the different detector can know that the failure is already managed by the failure information management apparatus 100, so that it is possible to prevent the help desk from receiving redundant reports, enabling to prevent generation of redundant failure information.

Therefore, it is possible to prevent an unnecessary increase in the number of pieces of the failure information managed by the failure information management apparatus 100. Consequently, in the case where a fee for a failure information management service (a fee for the help desk) is determined based on the number of pieces of the failure information managed by the failure information management apparatus 100 for example, it is possible to reduce the fee.

Further, in the first embodiment, if the failure information on the failure indicates recovery from the failure in the failure information management apparatus 100 that manages the failure that has occurred in the device 200, the device 200 cancels display of the notice indicating that the failure is managed by the failure information management apparatus 100. Therefore, when the same failure occurs again, it is possible to prevent the failure from remaining unresolved without a report to the help desk.

Furthermore, in the first embodiment, when a plurality of pieces of the display information are present, the display information with the highest priority is displayed on the device 200. Therefore, it is possible to provide a notice of the status of the failure with the highest priority.

### Second Embodiment

In a second embodiment, an example will be described in which a mediation device is used. In the following, differences from the first embodiment will be mainly described. Components having the same functions as those of the first embodiment will be denoted by the same name or the same symbols as those of the first embodiment, and explanation thereof will be omitted.

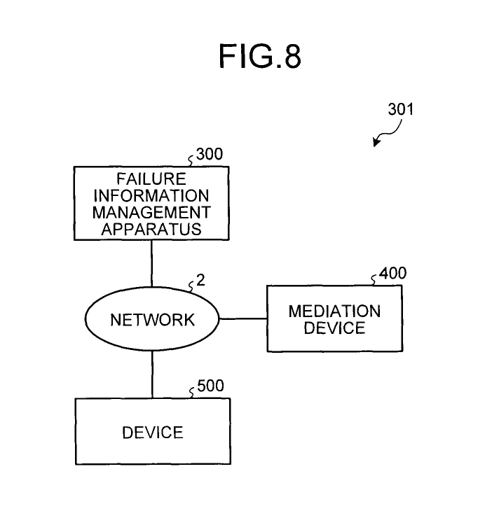

FIG. 8 is a block diagram illustrating an example of a configuration of a failure information management system 301 of the second embodiment. As illustrated in FIG. 8, in the second embodiment, the failure information management system 301 further includes a mediation device 400, and a failure information management apparatus 300 and a device 500 differ from those of the first embodiment.

The failure information management apparatus 300, the mediation device 400, and the device 500 are connected to one another via the network 2.

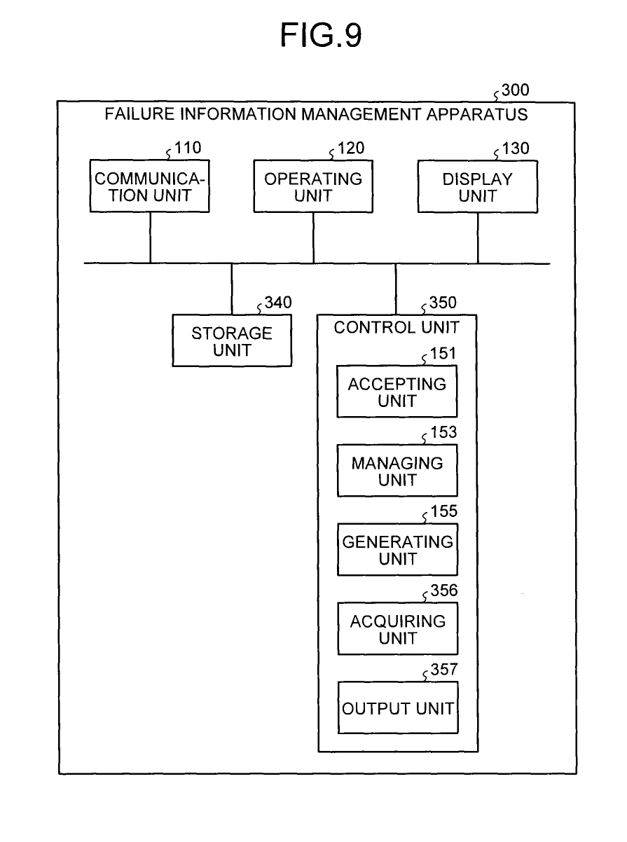

FIG. 9 is a block diagram illustrating an example of a configuration of the failure information management apparatus 300 of the second embodiment. As illustrated in FIG. 9, in the second embodiment, a storage unit 340 differs from the first embodiment, a control unit 350 further includes an acquiring unit 356, and an output unit 357 (an example of a first output unit) differs from the first embodiment.

The acquiring unit 356 acquires mediation device address information indicating an address of the mediation device 400 on the network. In the second embodiment, the mediation device address information is stored in the storage unit 340, and the acquiring unit 356 acquires the mediation device address information from the storage unit 340; however, it is not limited thereto. Further, in the second embodiment, it is assumed that the mediation device address information is the IP address of the mediation device 400; however, it is not limited thereto. For example, a host name of the mediation device 400 may be used.

The output unit 357 outputs the display information generated by the generating unit 155 to the mediation device 400. In the second embodiment, it is assumed that the output unit 357 outputs not only the display information but also the failure information containing the display information to the mediation device 400; however, it is not limited thereto. Consequently, the output unit 357 outputs the priority information or the like together with the display information to the mediation device 400.

Further, the output unit 357 outputs the display cancellation command generated by the generating unit 155 to the mediation device 400. In the second embodiment, it is assumed that, when the generating unit 155 generates the display cancellation command, the output unit 357 outputs the display cancellation command and the failure information used for generating the display cancellation command to the mediation device 400; however, it is not limited thereto.

Incidentally, the output unit 357 performs an output to the mediation device 400 based on the mediation device address information acquired by the acquiring unit 356. The output to the mediation device 400 may be performed by using communication using a dedicated protocol or by using an electronic mail or the like.

The mediation device 400 mediates communication between the failure information management apparatus 300 and the device 500, and may be, for example, a device management apparatus that manages the device 500.

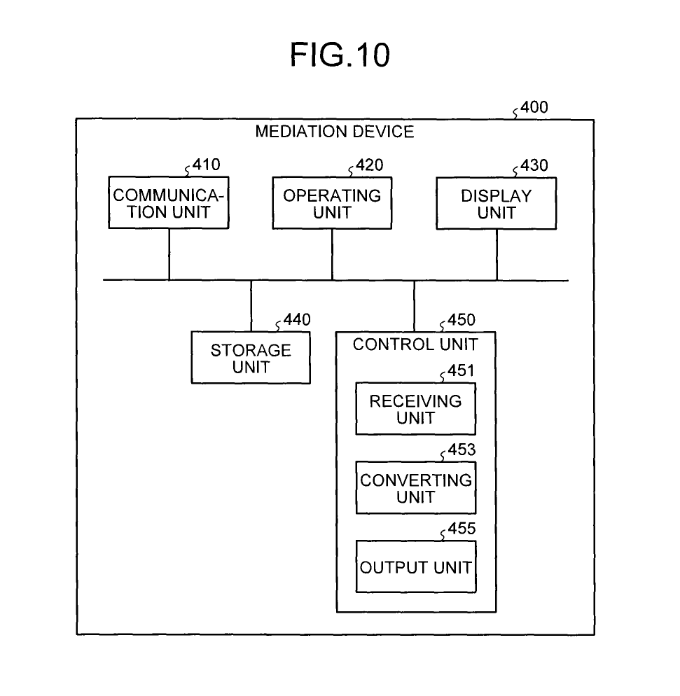

FIG. 10 is a block diagram illustrating an example of a configuration of the mediation device 400 of the second embodiment. As illustrated in FIG. 10, the mediation device 400 includes a communication unit 410, an operating unit 420, a display unit 430, a storage unit 440, and a control unit 450.

The communication unit 410 communicates with external devices, such as the failure information management apparatus 300 and the device 500, via the network 2, and is implemented by a communication device, such as a NIC.

The operating unit 420 receives various operations, and is implemented by an input device, such as a keyboard, a mouse, a touch pad, or a touch panel.

The display unit 430 displays various screens, and is implemented by a display device, such as a liquid crystal display or a touch panel display.

The storage unit 440 stores therein various programs executed by the mediation device 400, data used in various types of processing performed by the mediation device 400, and the like. The storage unit 440 is implemented by, for example, at least one of a magnetic storage device, an optical storage device, and an electrical storage device, such as an HDD, an SSD, a memory card, an optical disk, or a RAM.

The control unit 450 controls each of the units of the mediation device 400, and is implemented by a control device, such as a CPU. The control unit 450 includes a receiving unit 451, a converting unit 453, and an output unit 455 (an example of a second output unit). The control unit 450 activates (executes) the programs stored in the storage unit 440 and implements the receiving unit 451, the converting unit 453, and the output unit 455 as software.

The receiving unit 451 receives the display information from the failure information management apparatus 300. In the second embodiment, as described above, the receiving unit 451 receives the failure information containing the display information from the failure information management apparatus 300. Further, the receiving unit 451 receives the display cancellation command from the failure information management apparatus 300. In the second embodiment, as described above, the receiving unit 451 receives the display cancellation command and the failure information used for generating the display cancellation command from the failure information management apparatus 300.

The converting unit 453 converts the display information received by the receiving unit 451. For example, the converting unit 453 converts a display format of the display information contained in the failure information received by the receiving unit 451 to a display format of the device 500. However, if the display format of the display information matches the display format of the device 500, conversion is not needed.

The output unit 455 outputs the display information received by the receiving unit 451 to the device 500. In the second embodiment, it is assumed that the output unit 455 outputs not only the display information but also the failure information containing the display information to the device 500; however, it is not limited thereto. Consequently, the output unit 455 outputs the priority information or the like together with the display information to the device 500.

Further, the output unit 455 outputs the display cancellation command received by the receiving unit 451 to the device 500. In the second embodiment, it is assumed that, when the receiving unit 451 receives the display cancellation command, the output unit 455 outputs the display cancellation command and the failure information received with the display cancellation command to the device 500; however, it is not limited thereto.

Incidentally, the output unit 455 performs an output to the device 500 based on the device address information contained in the failure information. The output to the device 500 may be performed by using communication using a dedicated protocol or by using an electronic mail or the like.

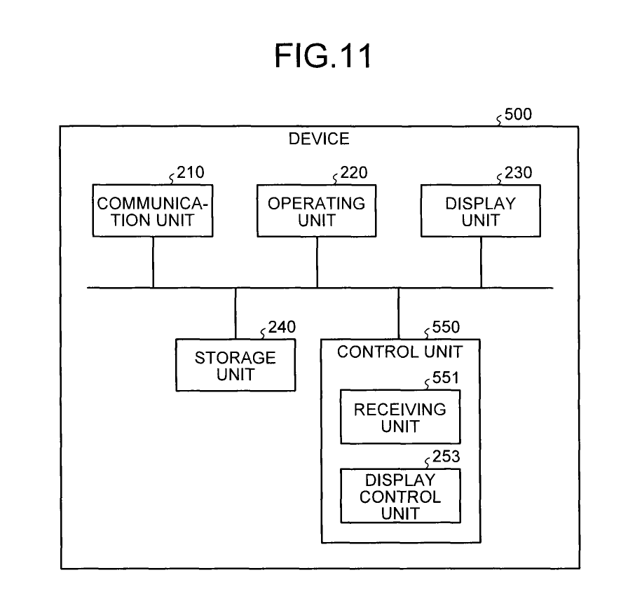

FIG. 11 is a block diagram illustrating an example of a configuration of the device 500 of the second embodiment. As illustrated in FIG. 11, in the second embodiment, a receiving unit 551 of a control unit 550 differs from the first embodiment.

The receiving unit 551 receives the display information from the mediation device 400. In the second embodiment, as described above, the receiving unit 551 receives the failure information containing the display information from the mediation device 400. Further, the receiving unit 551 receives the display cancellation command from the mediation device 400. In the second embodiment, as described above, the receiving unit 551 receives the display cancellation command and the failure information used for generating the display cancellation command from the mediation device 400.

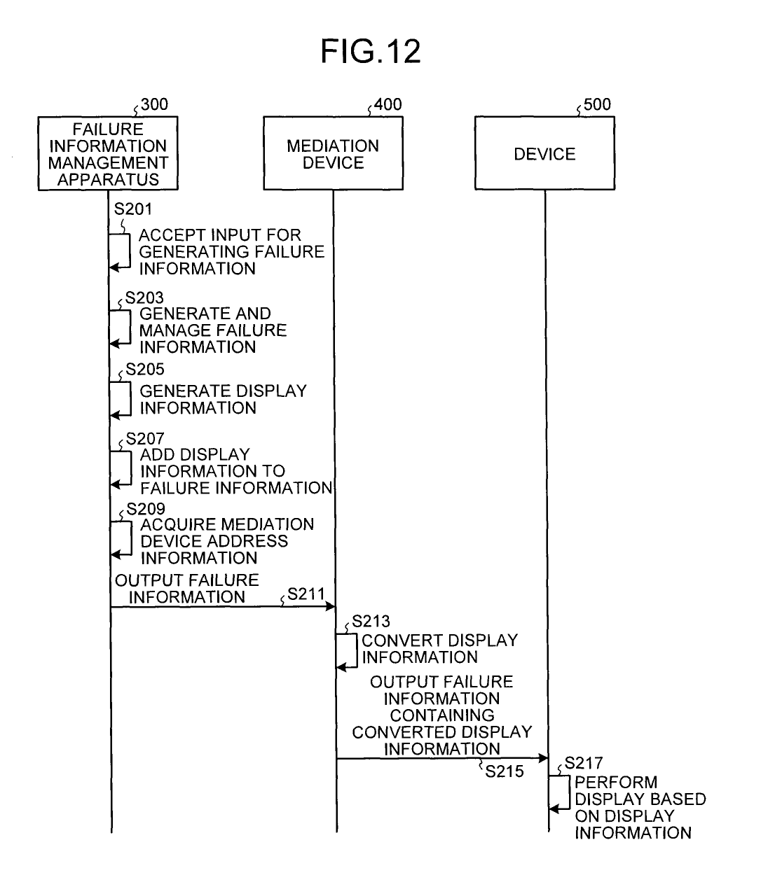

FIG. 12 is a sequence diagram illustrating an example of a display process performed by the failure information management system 301 of the second embodiment.

Processes from Steps S201 to S207 are the same as the processes from Steps S101 to S107 in the sequence diagram illustrated in FIG. 6.

Subsequently, the acquiring unit 356 of the failure information management apparatus 300 acquires the mediation device address information from the storage unit 340 (Step S209).

Then, the output unit 357 of the failure information management apparatus 300 outputs the failure information containing the display information generated by the generating unit 155 to the mediation device 400 (Step S211), and the receiving unit 451 of the mediation device 400 receives the failure information.

Subsequently, the converting unit 453 of the mediation device 400 converts a display format of the display information contained in the failure information received by the receiving unit 451 to a display format that is displayable by the device 500 (Step S213).

Then, the output unit 455 of the mediation device 400 outputs the failure information containing the display information converted by the converting unit 453 to the device 500 (Step S215), and the receiving unit 551 of the device 500 receives the failure information.

A subsequent process at Step S217 is the same as the process at Step S111 in the sequence diagram illustrated in FIG. 6.

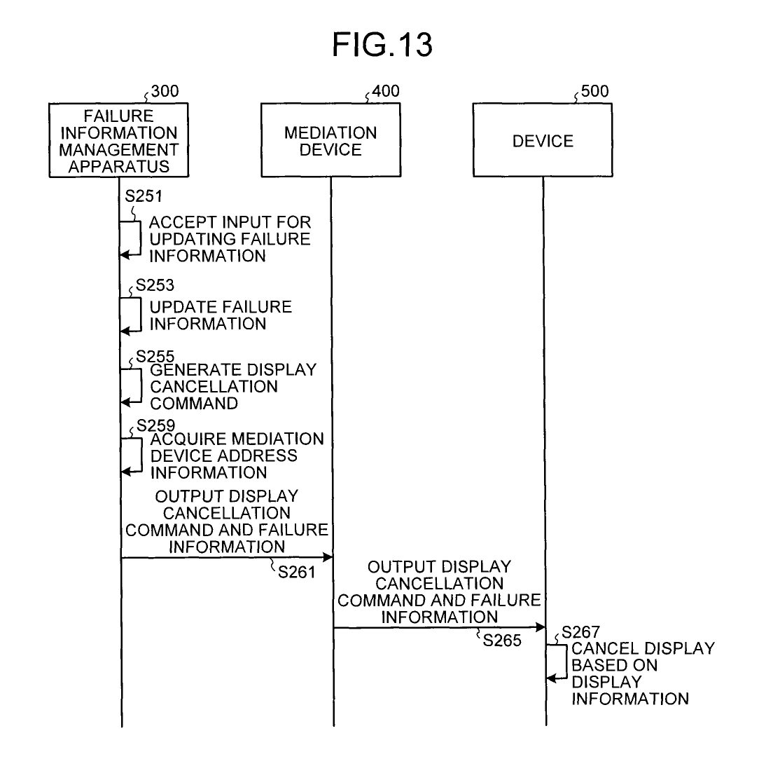

FIG. 13 is a sequence diagram illustrating an example of a display cancellation process performed by the failure information management system 301 of the second embodiment.

Processes from Steps S251 to S255 are the same as the processes from Steps S151 to S155 in the sequence diagram illustrated in FIG. 7.

Subsequently, the acquiring unit 356 of the failure information management apparatus 300 acquires the mediation device address information from the storage unit 340 (Step S259).

Then, the output unit 357 of the failure information management apparatus 300 outputs the display cancellation command generated by the generating unit 155 and the failure information used for generating the display cancellation command to the mediation device 400 (Step S261), and the receiving unit 451 of the mediation device 400 receives the display cancellation command and the failure information.

Subsequently, the output unit 455 of the mediation device 400 outputs the display cancellation command and the failure information received by the receiving unit 451 to the device 500 (Step S265), and the receiving unit 551 of the device 500 receives the display cancellation command and the failure information.

A subsequent process at Step S267 is the same as the process at Step S161 in the sequence diagram illustrated in FIG. 7.

As described above, in the second embodiment, it is possible to achieve the same advantageous effects as those of the first embodiment. In particular, because the second embodiment employs the mediation device 400, it is useful when the number of output destinations of the failure information from the failure information management apparatus 300 is limited to a predetermined number by contract or the like, for example.

Modification

The present invention is not limited to the above described embodiments, and may be modified in various forms. For example, in the above described embodiments, when a plurality of combinations of the display information and the priority information are present, that is, when a device receives a plurality of pieces of the failure information from the failure information management apparatus, the display control unit 253 causes the display unit 230 to perform display based on the display information paired with the priority information indicating the highest priority. However, it may be possible to cause the display unit 230 to perform display based on all pieces of the display information. In this case, the display control unit 253 may cause the display unit 230 to simultaneously display all pieces of the display information or to sequentially display each piece of the display information.

Hardware Configuration

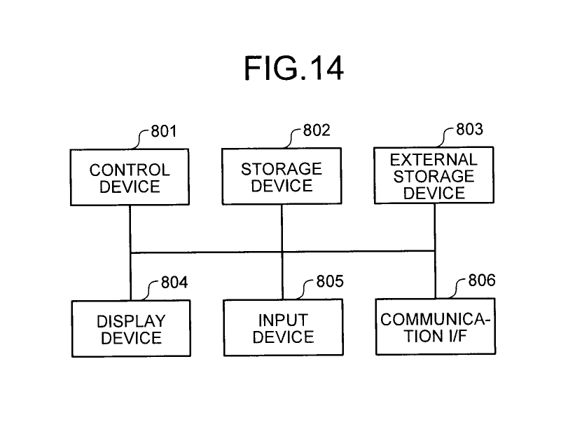

FIG. 14 is a diagram illustrating an example of a hardware configuration of each of the failure information management apparatus, the mediation device, and the device of the embodiments and the modification as described above (hereinafter, referred to as each device of the embodiments and the modification). Each device of the embodiments and the modification includes a control device 801, such as a CPU, a storage device 802, such as a ROM or a RAM, an external storage device 803, such as an HDD, a display device 804, such as a display, an input device 805, such as a keyboard or a mouse, and a communication interface (I/F) 806, and has a hardware configuration using a normal computer.

A program executed by each device of the embodiments and the modification is provided by being stored in a computer-readable storage medium, such as a CD-ROM, CD-R, a memory card, a digital versatile disk (DVD), or a flexible disk (FD), in a computer-installable or a computer-executable file format.

Further, the program executed by each device of the embodiments and the modification may be stored in a computer connected to a network, such as the Internet, and may be provided by being downloaded via the network. Furthermore, the program executed by each device of the embodiments and the modification may be provided or distributed via a network, such as the Internet. Moreover, the program executed by each device of the embodiments and the modification may be provided by being incorporated in a ROM or the like in advance.

The program executed by each device of the embodiments and the modification has a module structure to implement the above described units on a computer. As actual hardware, the CPU reads a program from the HDD onto the RAM and executes the program, so that each of the units is implemented on the computer.

According to an embodiment of the present invention, it is possible to prevent generation of redundant failure information.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A failure information management system comprising:
a failure information management apparatus; and
a device, wherein
the failure information management apparatus includes:
an accepting unit to accept an input for generating failure information on a failure that has occurred in the device;
a managing unit to manage the failure information generated based on the input accepted by the accepting unit;
a generating unit to generate display information indicating that the failure indicated by the failure information is managed by the failure information management apparatus; and
an output unit to output the display information to the device, and
the device includes:
a display control unit to causes a display unit to perform display based on the display information.

2. The failure information management system according to claim 1, wherein
the failure information contains status information indicating a status of the device, and
the generating unit generates the display information when the status information indicates occurrence of the failure.

3. The failure information management system according to claim 1, wherein
the generating unit generates a display cancellation command to cancel display of the display information when the status information indicates recovery from the failure,
the output unit outputs the display cancellation command generated by the generating unit to the device, and
the display control unit causes the display unit to cancel the display performed based on the display information according to the display cancellation command.

4. The failure information management system according to claim 1, wherein
the failure information further contains priority information indicating priority of the status information,
the output unit outputs the display information and the priority information to the device, and
the display control unit controls, based on the priority information, the display performed based on the display information on the display unit.

5. The failure information management system according to claim 4, wherein when a plurality of combinations of the display information and the priority information are present, the display control unit causes the display unit to perform display based on display information paired with priority information indicating highest priority.

6. The failure information management system according to claim 1, wherein
the failure information management apparatus and the device are connected to each other via a network,
the failure information further contains device address information indicating an address of the device on the network, and
the output unit performs an output to the device based on the device address information.

7. A failure information management system comprising:
a failure information management apparatus;
a mediation device; and
a device, wherein
the failure information management apparatus includes:
an accepting unit to accept an input for generating failure information on a failure that has occurred in the device;
a managing unit to manage the failure information generated based on the input accepted by the accepting unit;
a generating unit to generate display information indicating that the failure indicated by the failure information is managed by the failure information management apparatus; and
a first output unit to output the display information to the mediation device,
the mediation device includes:
a second output unit to output the display information to the device, and
the device includes:
a display control unit to cause a display unit to perform display based on the display information.

8. The failure information management system according to claim 7, wherein
the failure information contains status information indicating a status of the device, and
the generating unit generates the display information when the status information indicates occurrence of the failure.

9. The failure information management system according to claim 7, wherein
the generating unit generates a display cancellation command to cancel display of the display information when the status information indicates recovery from the failure,
the first output unit outputs the display cancellation command generated by the generating unit to the mediation device,
the second output unit outputs the display cancellation command output by the first output unit to the device, and
the display control unit causes the display unit to cancel the display performed based on the display information according to the display cancellation command.

10. The failure information management system according to claim 7, wherein
the failure information further contains priority information indicating priority of the status information,
the first output unit outputs the display information and the priority information to the mediation device,
the second output unit outputs the display information and the priority information to the device, and
the display control unit controls, based on the priority information, the display performed based on the display information on the display unit.

11. The failure information management system according to claim 10, wherein when a plurality of combinations of the display information and the priority information are present, the display control unit causes the display unit to perform display based on display information paired with priority information indicating highest priority.

12. The failure information management system according to claim 7, wherein
the failure information management apparatus, the mediation device, and the device are connected to one another via the network,
the failure information management apparatus further includes an acquiring unit to acquire mediation device address information indicating an address of the mediation device on the network,
the failure information further contains device address information indicating an address of the device on the network,
the first output unit outputs the display information and the device address information to the mediation device based on the mediation device address information, and
the second output unit outputs the display information to the device based on the device address information.

13. The failure information management system according to claim 7, wherein
the mediation device further includes a converting unit to convert the display information, and
the second output unit outputs the converted display information to the device.

14. The failure information management system according to claim 1, wherein when a plurality of pieces of the display information are present, the display control unit causes the display unit to perform display based on the pieces of the display information.

15. A failure information management apparatus that manages a failure that has occurred in a management target device, the failure information management apparatus comprising:
an accepting unit to accept an input for generating failure information on the failure;
a managing unit to manage the failure information generated based on the input accepted by the accepting unit;
a generating unit to generate display information for displaying, on the device, a notice indicating that the failure indicated by the failure information is managed by the failure information management apparatus, and
an output unit that outputs the display information.
